(19) United States
(12) Patent Application Publication
(10) Pub. No.: US 2025/0119210 A1
(43) Pub. Date: Apr. 10, 2025

(54) LANDING STATION IDENTIFICATION APPARATUS, LANDING STATION IDENTIFICATION METHOD, AND NON-TRANSITORY STORAGE MEDIUM

(71) Applicant: NEC Corporation, Minato-ku, Tokyo (JP)

(72) Inventor: Taiki Kanai, Tokyo (JP)

(73) Assignee: NEC Corporation, Minato-ku, Tokyo (JP)

(21) Appl. No.: 18/730,881

(22) PCT Filed: Mar. 2, 2022
(86) PCT No.: PCT/JP2022/008773

§ 371 Date: Jul. 22, 2024

(51) Int. Cl. H04B 10/03; H04B 10/25

(52) U.S. Cl. CPC H04B 10/03; H04B 10/25

(57) ABSTRACT

A landing station identification apparatus includes a cable identification means for identifying a first cable capable of transmitting an optical signal to a first optical branching apparatus, based on a failure occurrence status of a plurality of first cables connected to the first optical branching apparatus; adjacent object identification means for identifying an adjacent object connected to the first optical branching apparatus via the identified first cable and a landing station and a landing station identification means for identifying the landing station as a landing station capable of controlling the first optical branching apparatus when the identified adjacent object is the landing station. The adjacent object connected to the first optical branching apparatus includes a second optical branching apparatus other than the first optical branching apparatus.

### TECHNICAL FIELD

The present disclosure relates to a submarine cable system.

### BACKGROUND ART

In recent years, there have been proposed various techniques for continuously controlling an optical branching apparatus associated with a failure when the failure occurs in a submarine cable connecting a plurality of optical branching apparatuses to one another.

As one example of such techniques, a submarine cable system disclosed in Patent Literature 1 includes an optical branching apparatus, a first terminal station apparatus capable of communicating with the optical branching apparatus, a second terminal station apparatus capable of communicating with the optical branching apparatus, and a control apparatus. When disconnection of a submarine cable between a third terminal station apparatus that outputs a control signal and the optical branching apparatus is detected, the control apparatus selects any one of the first terminal station apparatus and the second terminal station apparatus according to a predetermined priority order, and instructs the one being selected to output a control signal to the optical branching apparatus.

### CITATION LIST

### Patent Literature

Patent Literature 1: International Patent Publication No. WO2021/044993

### SUMMARY OF INVENTION

### Technical Problem

However, the control apparatus disclosed in Patent Literature 1 selects any one of the first terminal station apparatus and the second terminal station apparatus according to a priority order based on a distance from the first terminal station apparatus to the optical branching apparatus and a distance from the second terminal station apparatus to the optical branching apparatus. Thus, when a failure occurs on a cable that connects the selected terminal station apparatus and the optical branching apparatus to each other, the optical branching apparatus cannot receive a control signal transmitted from the selected terminal station apparatus. In other words, in the submarine cable system disclosed in Patent Literature 1, there is a problem that a landing station including a terminal station apparatus capable of controlling the optical branching apparatus associated with a cable failure cannot be identified.

In view of the above-mentioned problem, an object of the present disclosure is to provide a landing station identification apparatus, a landing station identification method, and a landing station identification program that are able to identify a landing station capable of controlling an optical branching apparatus included in a submarine cable system.

### Solution to Problem

According to one exemplary aspect, a landing station identification apparatus includes:
a cable identification means for identifying a first cable capable of transmitting an optical signal to a first optical branching apparatus, based on a failure occurrence status of a plurality of first cables connected to the first optical branching apparatus;
an adjacent object identification means for identifying an adjacent object connected to the first optical branching apparatus via the identified first cable and a landing station, wherein the adjacent object connected to the first optical branching apparatus includes a second optical branching apparatus other than the first optical branching apparatus; and
a landing station identification means for identifying the landing station as a landing station capable of controlling the first optical branching apparatus when the identified adjacent object is the landing station.

According to one exemplary aspect, a landing station identification method includes by a computer:
identifying a first cable capable of transmitting an optical signal to a first optical branching apparatus, based on a failure occurrence status of a plurality of first cables connected to the first optical branching apparatus;
identifying an adjacent object connected to the first optical branching apparatus via the identified first cable and a landing station, wherein the adjacent object connected to the first optical branching apparatus includes a second optical branching apparatus other than the first optical branching apparatus; and
identifying the landing station as a landing station capable of controlling the first optical branching apparatus when the identified adjacent object is the landing station.

According to one exemplary aspect, a landing station identification program causes a computer to execute:
identifying a first cable capable of transmitting an optical signal to a first optical branching apparatus, based on a failure occurrence status of a plurality of first cables connected to the first optical branching apparatus;
identifying an adjacent object connected to the first optical branching apparatus via the identified first cable and a landing station, wherein the adjacent object connected to the first optical branching apparatus includes a second optical branching apparatus other than the first optical branching apparatus; and
identifying the landing station as a landing station capable of controlling the first optical branching apparatus when the identified adjacent object is the landing station.

### Advantageous Effects of Invention

According to the present disclosure, it is possible to provide a landing station identification apparatus, a landing station identification method, and a landing station identification program that are able to identify a landing station capable of controlling an optical branching apparatus included in a submarine cable system.

### BRIEF DESCRIPTION OF DRAWINGS

FIG. 1 is a diagram illustrating a submarine cable according to an exemplary first example embodiment;

FIG. 2 is a diagram illustrating a configuration of a landing station T1;

FIG. 3 is a diagram illustrating a configuration of a landing station T3;

FIG. 4 is a diagram illustrating a configuration of an integrated monitoring control apparatus according to the exemplary first example embodiment;

FIG. 5 is a flowchart illustrating one example of processing executed by the integrated monitoring control apparatus according to the exemplary first example embodiment;

FIG. 6 is a flowchart illustrating one example of the processing executed by the integrated monitoring control apparatus according to the exemplary first example embodiment;

FIG. 7 is a flowchart illustrating one example of the processing executed by the integrated monitoring control apparatus according to the exemplary first example embodiment;

FIG. 8 is a diagram illustrating one example of a failure occurrence status management table;

FIG. 9 is a diagram illustrating a cable capable of transmitting an optical signal, based on the failure occurrence status management table in FIG. 8;

FIG. 10 is a diagram illustrating one example of an adjacent object information table according to the first example embodiment;

FIG. 11 is a diagram illustrating one example of an optical switch connection state table;

FIG. 12 is a diagram illustrating a failure occurrence status of a submarine cable system, based on the failure occurrence status management table in FIG. 8;

FIG. 13 is a diagram illustrating main constituent elements included in the integrated monitoring control apparatus according to the exemplary first example embodiment;

FIG. 14 is a diagram illustrating one example of a submarine cable system according to an exemplary second example embodiment;

FIG. 15 is a flowchart illustrating one example of processing executed by an integrated monitoring control apparatus according to the exemplary second example embodiment;

FIG. 16 is a flowchart illustrating one example of the processing executed by an integrated monitoring control apparatus according to the exemplary second example embodiment;

FIG. 17 is a flowchart illustrating one example of the processing executed by an integrated monitoring control apparatus according to the exemplary second example embodiment;

FIG. 18 is a flowchart illustrating one example of the processing executed by an integrated monitoring control apparatus according to the exemplary second example embodiment;

FIG. 19 is one example of an adjacent object information table used in the second example embodiment;

FIG. 20 is a diagram illustrating one example of pass-through setting information relating to an optical branching insertion apparatus;

FIG. 21 is a diagram illustrating one example of a failure occurrence status management table in which a failure occurrence status of a cable connected to the optical branching insertion apparatus is registered;

FIG. 22 is a diagram illustrating one example of the adjacent object information table in which an adjacent object of the optical branching insertion apparatus is registered; and

FIG. 23 is a diagram illustrating one example of the submarine cable system when a cable failure according to the exemplary second example embodiment occurs.

### EXAMPLE EMBODIMENT

### First Example Embodiment

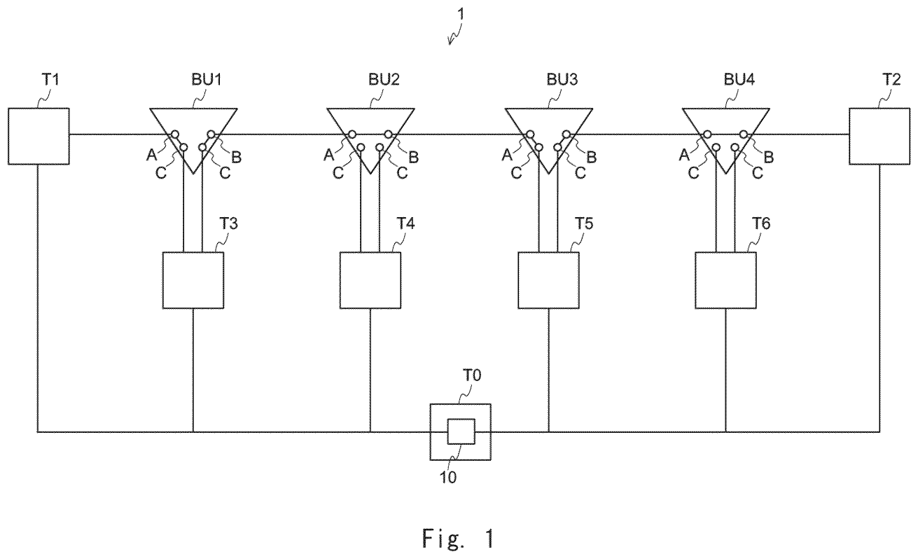

With reference to the drawings exemplary example embodiments are described below. FIG. 1 is a diagram illustrating one example of a submarine cable system 1 according to an exemplary first example embodiment. The submarine cable system 1 includes a network operation center (NOC) T0 in which an integrated monitoring control apparatus 10 is installed, one or more landing stations T1 to T6, and one or more optical branching apparatus BU1 to BU4.

The optical branching apparatuses BU1 to BU4 are connected to each other via a submarine cable, and are capable of mutually transmitting an optical signal. Further, the optical branching apparatuses BU1 to BU4 and the landing stations T1 to T6 are connected to each other via the submarine cable, and are capable of mutually transmitting an optical signal. Further, the integrated monitoring control apparatus 10 and the landing stations T1 to T6 are connected to each other via the cable, and are capable of mutually transmitting a signal. Note that the numbers of landing stations and optical branching apparatuses that are illustrated in FIG. 1 are merely examples, and the submarine cable system 1 may include the freely-selected numbers of landing stations and optical branching apparatuses.

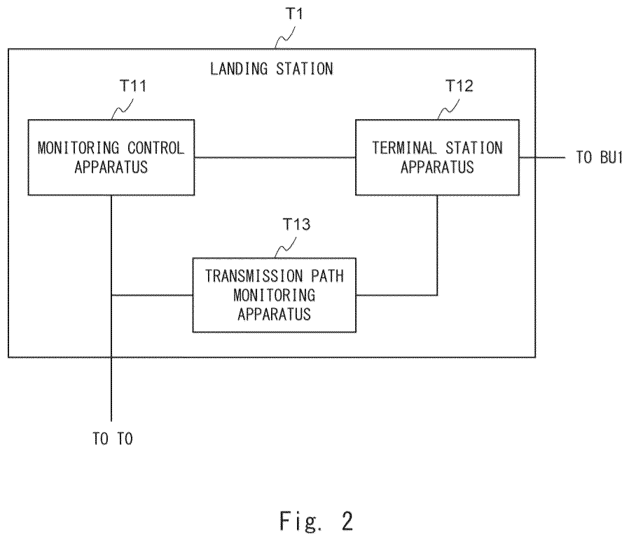

FIG. 2 is a diagram illustrating a configuration of the landing station T1. The landing station T2 is configured similarly to the landing station T1. The landing station T1 includes a monitoring control apparatus T11, a terminal station apparatus T12, and A transmission path monitoring apparatus T13.

The monitoring control apparatus T11 is an apparatus that controls the terminal station apparatus T12 and the optical branching apparatus. Specific examples of the monitoring control apparatus T11 include an element management system (EMS) and the like. The monitoring control apparatus T11 is capable of transmitting a control command for the optical branching apparatus, for example, control information such as a power supply switching command, to the terminal station apparatus T12.

The terminal station apparatus T12 converts an electric signal being received from the monitoring control apparatus T11 or the transmission path monitoring apparatus T13 into an optical signal, and transmit the optical signal to the submarine cable. When control information for the optical branching apparatus is received from the monitoring control apparatus T11, the terminal station apparatus T12 transmits the control information to the optical branching apparatus BU1 via the submarine cable.

Further, the terminal station apparatus T12 converts an optical signal being received from the submarine cable into an electric signal, and transmits the electric signal to the monitoring control apparatus T11 or the transmission path monitoring apparatus T13.

The transmission path monitoring apparatus T13 is an apparatus that monitors a failure occurrence status of the submarine cable. Specific examples of the transmission path monitoring apparatus T13 include remote fiber test equipment (RFTE) and the like. The transmission path monitoring apparatus T13 provides information indicating the failure occurrence status of the submarine cable to the integrated monitoring control apparatus 10.

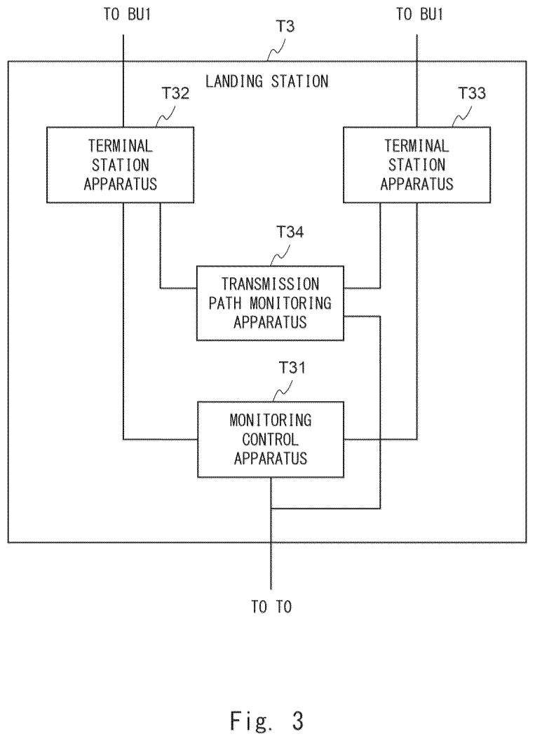

FIG. 3 is a diagram illustrating a configuration of the landing station T3. The landing stations T4 to T6 are configured similarly to the landing station T3. The landing station T3 includes a monitoring control apparatus T31, terminal stations apparatuses T32 and T33, and a transmission path monitoring apparatus T34. The monitoring control apparatus T31, the terminal stations apparatuses T32 and T33, and the transmission path monitoring apparatus T34 includes the same functions as the monitoring control apparatus T11, the terminal station apparatus T12, and the transmission path monitoring apparatus T13 of the landing station T1.

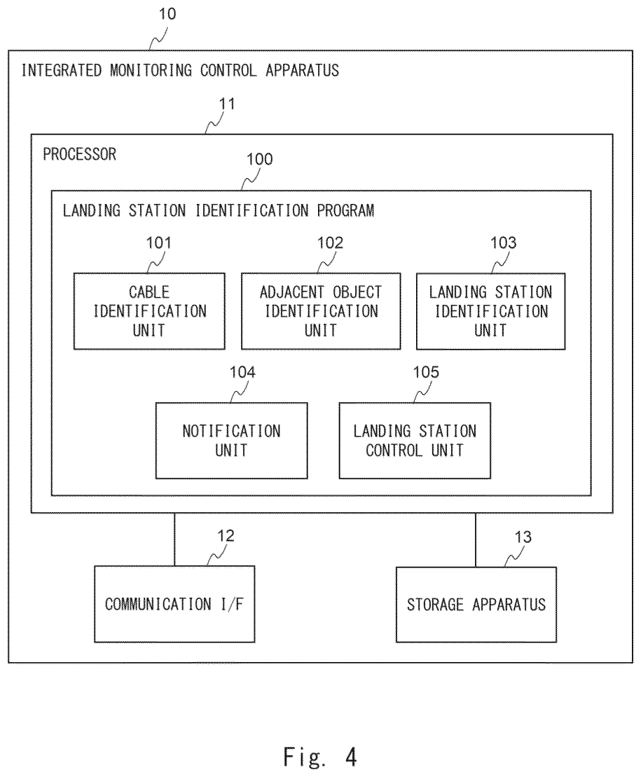

FIG. 4 is a diagram illustrating a configuration of the integrated monitoring control apparatus 10 according to the exemplary first example embodiment. The integrated monitoring control apparatus 10 is an apparatus that monitors and controls the submarine cable system 1 as a whole. Specific examples of the integrated monitoring control apparatus 10 include a unified management system (UMS) and the like.

The integrated monitoring control apparatus 10 includes a processor 11 capable of executing various programs, a communication interface (I/F) 12, and a storage apparatus 13. Specific examples of the processor 11 include various processors such as a central processing unit (CPU) and a micro processing unit (MPU). In the storage apparatus 13, various types of information to be processed by the processor 11, for example, a landing station identification program 100, data tables described later, and the like are stored. The integrated monitoring control apparatus 10 corresponds to a landing station identification apparatus. The integrated monitoring control apparatus 10 can be achieved by a computer.

The processor 11 reads out and executes the landing station identification program 100 from the storage apparatus 13, and thus executes a landing station identification method according to the first example embodiment. The landing station identification program 100 includes a cable identification unit 101, an adjacent object identification unit 102, a landing station identification unit 103, a notification unit 104, a landing station control unit 105. Note that the functions of the landing station identification program 100 may be achieved by an integrated circuit such as a field-programmable gate array (FPGA) and an application specific integrated circuit (ASIC). The processor and the integrated circuit such as an FPGA and an ASIC correspond to a computer.

The cable identification unit 101 is a program for identifying a first cable capable of transmitting an optical signal to a first optical branching apparatus, based on a failure occurrence status of a plurality of first cables connected to the first optical branching apparatus being a control target.

The adjacent object identification unit 102 is a program for identifying an adjacent object connected to the first optical branching apparatus via the first cable being identified by the cable identification unit 101. In the exemplary first example embodiment, an optical branching apparatus other than the first optical branching apparatus and the landing stations T1 to T6 may be the adjacent object.

The landing station identification unit 103 is a program for identifying a landing station capable of controlling the first optical branching apparatus. When the adjacent object being identified by the adjacent object identification unit 102 is a landing station, the landing station identification unit 103 identifies the landing station as a landing station capable of controlling the first optical branching apparatus.

The notification unit 104 is a program for sending the landing station being identified by the landing station identification unit 103. The notification unit 104 is capable of notifying an operator of the integrated monitoring control apparatus 10 or the like of the landing station being identified.

The landing station control unit 105 is a program for preventing a terminal station apparatus of a landing station other than the landing station being identified by the landing station identification unit 103 to transmit control information to the first optical branching apparatus. The landing station control unit 105 transmits, to a terminal station apparatus of a landing station other than the landing station being identified, a control command for preventing transmission of control information to the first optical branching apparatus. When the control command is received, the terminal station apparatuses of the landing stations T1 to T6 do not execute transmission of control information to the first optical branching apparatus.

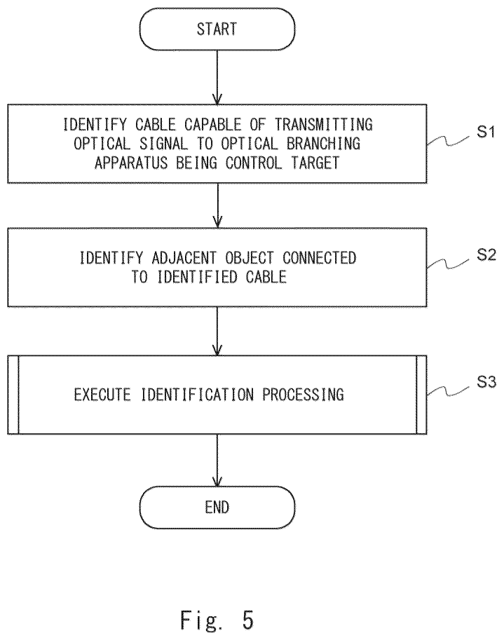

FIG. 5 to FIG. 7 are flowcharts illustrating one example of processing to be executed by the integrated monitoring control apparatus 10. In step S1, the integrated monitoring control apparatus 10 identifies a cable capable of transmitting an optical signal to an optical branching apparatus being a control target, based on a failure occurrence status of a plurality of cables connected to the optical branching apparatus being a control target.

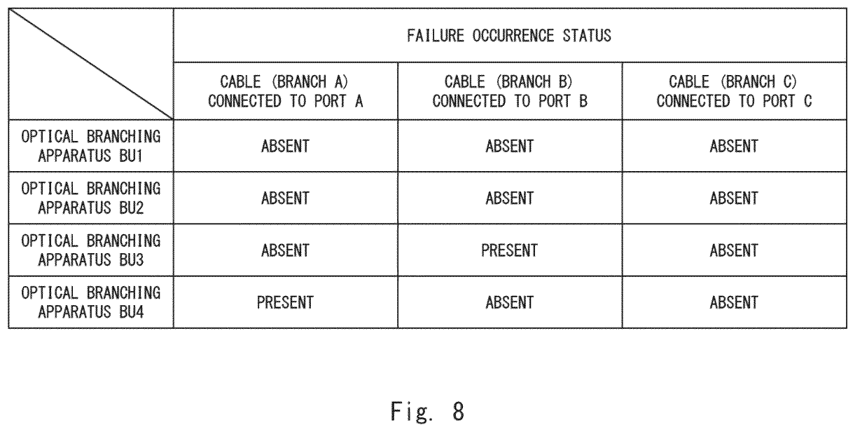

Specifically, the integrated monitoring control apparatus 10 identifies a cable capable of transmitting an optical signal, based on a failure occurrence status of a cable connected to each port of the optical branching apparatus being a control target. FIG. 8 illustrates one example of a failure occurrence status management table. In the failure occurrence status management table, a failure occurrence status of a cable that is provided by the transmission path monitoring apparatus of each of the landing stations is registered.

FIG. 12 illustrates a failure occurrence status of the submarine cable system 1, based on the failure occurrence status management table in FIG. 8. In this example, a failure occurs on a cable between the optical branching apparatus BU3 and the optical branching apparatus BU4. Herein, it is assumed that the optical branching apparatus BU3 is an optical branching apparatus being a control target. With reference to failure occurrence statuses of cables connected to the optical branching apparatus BU3 in the failure occurrence status management table in FIG. 8, a failure does not occur on a cable (branch A) connected to a port A and a cable (branch C) connected to a port C of the optical branching apparatus BU3. Meanwhile, a failure occurs on a cable connected to a port B (branch B). In this case, the integrated monitoring control apparatus 10 identifies the cable (branch A) connected to the port A and the cable (branch C) connected to the port C of the optical branching apparatus BU3 as cables capable of transmitting an optical signal.

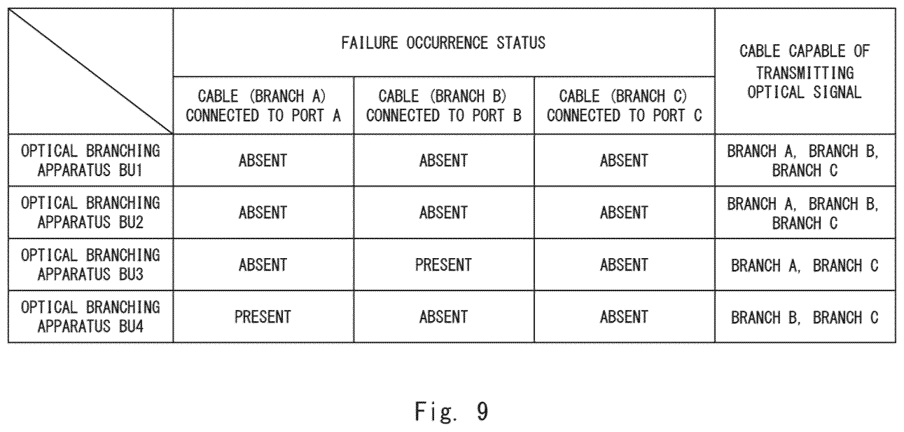

Note that, in the submarine cable system 1, when the cable failures indicated in the failure occurrence status management table in FIG. 8 occur, cables capable of transmitting an optical signal among the cables connected to the optical branching apparatuses BU1 to BU4 is as indicated in FIG. 9.

In step S2, the integrated monitoring control apparatus 10 refers to an adjacent object information table, and identifies an adjacent object connected to the cable being identified in step S1.

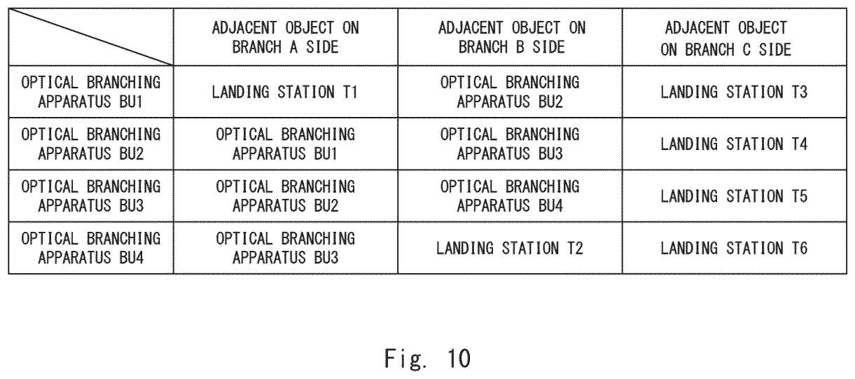

FIG. 10 illustrates one example of the adjacent object information table according to the first example embodiment. In the adjacent object information table, an adjacent object on the branch A side, an adjacent object on the branch B side, and an adjacent object on the branch C side of each of the optical branching apparatuses BU1 to BU4 is registered. With reference to the adjacent object information table illustrated in FIG. 10, the adjacent object on the branch A side of the optical branching apparatus BU3 is the optical branching apparatus BU2, and the adjacent object on the branch C side is the landing station T5. In this case, the integrated monitoring control apparatus 10 identifies the optical branching apparatus BU2 as the adjacent object on the branch A side of the optical branching apparatus BU3, and identifies the landing station T5 as the adjacent object on the branch C side of the optical branching apparatus BU3.

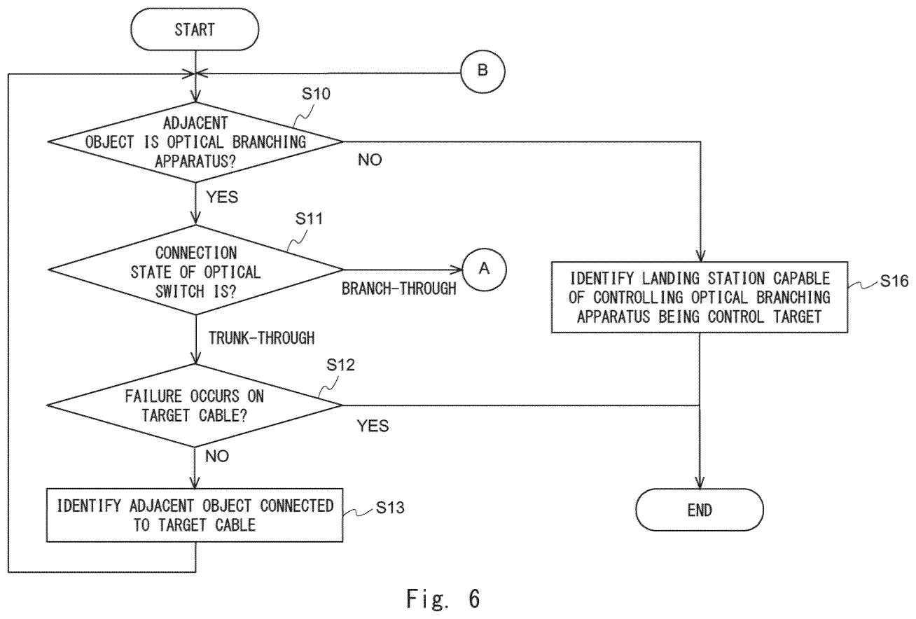

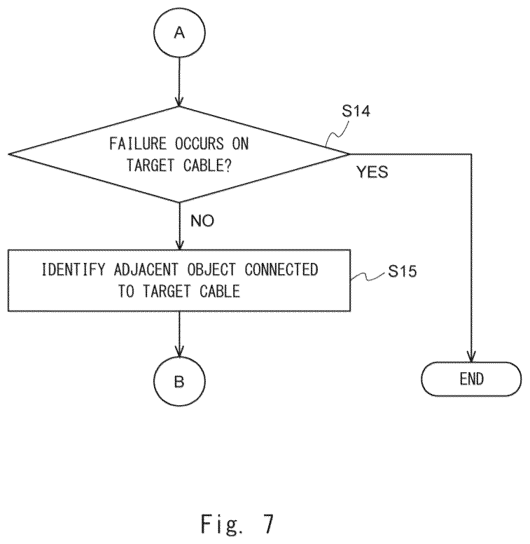

In step S3, the integrated monitoring control apparatus 10 executes identification processing illustrated in FIG. 6 and FIG. 7 for each of the adjacent objects being identified in step S2, and the processing in FIG. 5 is terminated.

In the example illustrated in FIG. 12, when the processing in the FIG. 5 is executed, the optical branching apparatus BU2 and the landing station T5 are identified as adjacent objects of the optical branching apparatus BU3 being a control target. The processing illustrated in FIG. 6 and FIG. 7 is executed for each of the optical branching apparatus BU2 and the landing station T5.

FIG. 6 and FIG. 7 are diagrams illustrating one example of identification processing to be executed by the integrated monitoring control apparatus 10 according to the first example embodiment. In step S10, the integrated monitoring control apparatus 10 determines whether the adjacent object being identified is an optical branching apparatus. When the adjacent object being identified is an optical branching apparatus (YES), the processing branches to step S11.

In step S11, the integrated monitoring control apparatus 10 refers to an optical switch connection state table, and determines a connection state of an optical switch of the optical branching apparatus being the adjacent object being identified.

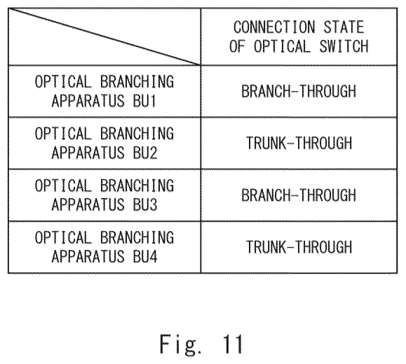

FIG. 11 is a diagram illustrating a diagram illustrating one example of the optical switch connection state table. In the optical switch connection state table, the connection state of the optical switch included in each of the optical branching apparatuses BU1 to BU4 is registered. Trunk-through is a connection state in which adjacent optical branching apparatuses can be connected to each other. In the example illustrated in FIG. 1, the connection states of the optical switches of the optical branching apparatuses BU2 and BU4 are trunk-through. Note that, when the connection state of the optical switch of the optical branching apparatus positioned at the end of the submarine cable system 1 is trunk-through, the adjacent optical branching apparatus and the adjacent landing station are connected to each other. For example, when the connection state of the optical switch of the optical branching apparatus BU4 is trunk-through, the adjacent optical branching apparatus BU3 and the adjacent landing station T2 are connected to each other.

Branch-through is a connection state in which an adjacent landing station and an adjacent optical branching apparatus can be connected to each other. In the example illustrated in FIG. 1, the connection states of the optical switches of the optical branching apparatuses BU1 and BU3 are branch-through. Note that, when the connection state of the optical switch of the optical branching apparatus positioned at the end of the submarine cable system 1 is branch-through, the adjacent landing stations are connected to each other. For example, when the connection state of the optical switch of the optical branching apparatus BU1 is branch-through, the adjacent landing stations T1 and T3 are connected to each other.

When the connection state of the optical switch is trunk-through in step S11, the processing branches to step S12. In step S12, the integrated monitoring control apparatus 10 refers to the failure occurrence status management table, and determines whether a failure occurs on a target cable for which presence or absence of failure occurrence is not yet determined, among the cables connected to the optical switch connected by the optical switch of the optical branching apparatus being the adjacent object.

For example, in the example illustrated in FIG. 12, one of the adjacent objects of the optical branching apparatus BU3 being a control target is the optical branching apparatus BU2. In this state, presence or absence of failure occurrence is previously determined for the cable (branch B) of the optical branching apparatus BU2 on the optical branching apparatus BU3 side in step S1, and hence the cable (branch A) of the optical branching apparatus BU2 on the optical branching apparatus BU1 is the target cable.

When a failure occurs on the target cable (YES), the identification processing is terminated. In contrast, when a failure does not occur on the target cable (NO), the processing branches to step S13.

In step S13, the integrated monitoring control apparatus 10 refers to the adjacent object information table identifies the adjacent object connected to the target cable, and the processing returns to step S10. In this case, in step S10, the integrated monitoring control apparatus 10 determines whether the adjacent object being identified is an optical branching apparatus in step S13.

In contrast, when it is determined that the connection state of the optical switch is branch-through in step S11, the processing branches to step S14. In step S14, the integrated monitoring control apparatus 10 refers to the failure occurrence status management table, and determines whether a failure occurs on a target cable for which presence or absence of failure occurrence is not yet determined, among the cables connected to the optical switch connected by the optical switch of the optical branching apparatus being the adjacent object. When a failure occurs on the target cable (YES), the identification processing is terminated. In contrast, when a failure does not occur on the target cable (NO), the processing branches to step S15.

In step S15, the integrated monitoring control apparatus 10 refers to the adjacent object information table identifies the adjacent object connected to the target cable, and the processing returns to step S10. In this case, in step S10, the integrated monitoring control apparatus 10 determines whether the adjacent object being identified is an optical branching apparatus in step S15.

In contrast, when it is determined that the adjacent object is not an optical branching apparatus in step S10 (NO), in other words, when the adjacent object is a landing station, the processing branches to step S16. In step S16, the integrated monitoring control apparatus 10 identifies the landing station being the adjacent object as a landing station capable of controlling the optical branching apparatus being a control target, and the identification processing is terminated.

In the example illustrated in FIG. 12, description is made on a case in which the processing FIG. 6 and FIG. 7 is executed for the landing station T5 and the optical branching apparatus BU2 that are the adjacent objects of the optical branching apparatus BU3 being a control target. The landing station T5 is a landing station, and hence the landing station T5 is identified as one of the landing stations capable of controlling the optical branching apparatus BU3 being a control target.

Meanwhile, for the optical branching apparatus BU2, the optical branching apparatus BU1 is identified as the adjacent object of the optical branching apparatus BU2, based on the connection state of the optical switch of the optical branching apparatus BU2 and the failure occurrence statuses of the cables connected to the optical branching apparatus BU2. Sequentially, the landing station T3 is identified as the adjacent object of the optical branching apparatus BU1, based on the connection state of the optical switch of the optical branching apparatus BU1 and the failure occurrence status of the cables connected to the optical branching apparatus BU1. Further, the landing station T3 is identified as one of the landing stations capable of controlling the optical branching apparatus BU3 being a control target.

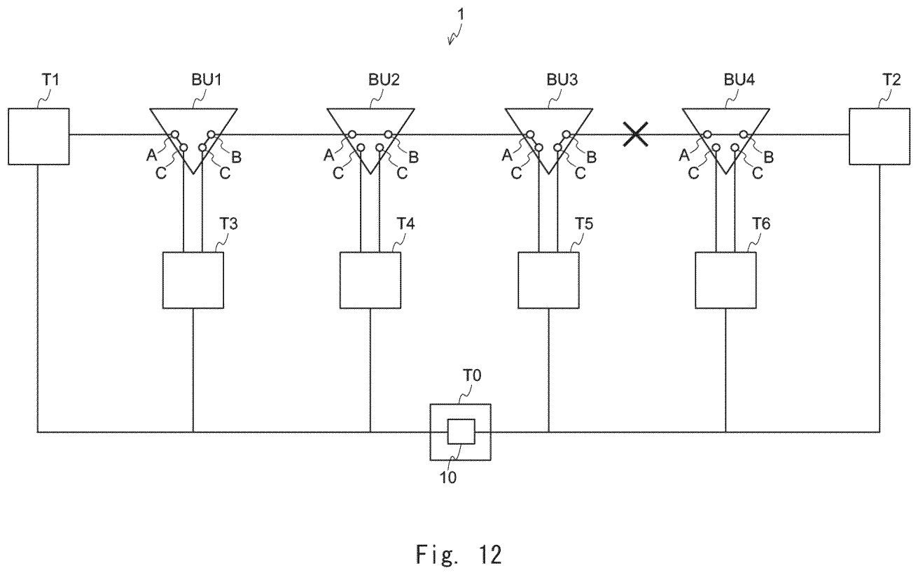

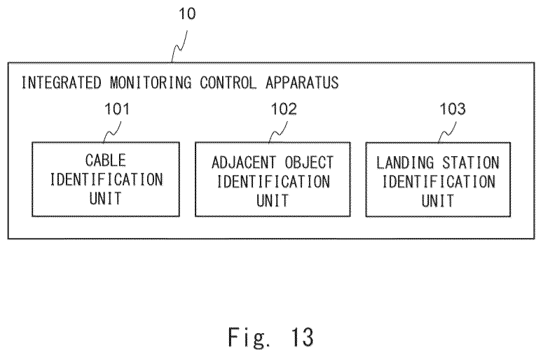

FIG. 13 is a diagram illustrating main constituent elements included in the integrated monitoring control apparatus 10 according to the exemplary first example embodiment. The integrated monitoring control apparatus 10 includes the cable identification unit 101, the adjacent object identification unit 102, and the landing station identification unit 103.

In the exemplary first example embodiment, the cable identification unit 101 identifies the first cable capable of transmitting an optical signal to the first optical branching apparatus, based on the failure occurrence statuses of the plurality of first cables connected to the first optical branching apparatus being a control target (step S1 in FIG. 5). Subsequently, the adjacent object identification unit 102 identifies the adjacent object connected to the first optical branching apparatus via the first cable being identified (step S2 in FIG. 5). When the adjacent object being identified is a landing station, the landing station identification unit 103 identifies the landing station as a landing station capable of controlling the first optical branching apparatus (step S16 in FIG. 6). With this, a landing station capable of controlling the optical branching apparatus being a control target can be identified.

Further, when a first adjacent object being identified by the adjacent object identification unit 102 is a second optical branching apparatus, the adjacent object identification unit 102 executes adjacent object identification processing (step S13 in FIG. 6 and step S15 in FIG. 7) for identifying an adjacent object connected to the second optical branching apparatus via a second cable capable of transmitting an optical signal to the second optical branching apparatus, among a plurality of second cables connected to the second optical branching apparatus. Further, when the adjacent object connected to the second optical branching apparatus is a landing station, the landing station identification unit 103 executes landing station processing (step S16 in FIG. 6) for identifying the landing station as a landing station capable of controlling the first optical branching apparatus.

With this, even when one optical branching apparatus is present between an optical branching apparatus being a control target and a landing station, a landing station capable of controlling the optical branching apparatus being a control target can be identified.

Further, the second cable capable of transmitting an optical signal to the second optical branching apparatus is identified based on a connection state of an optical switch included in the second optical branching apparatus and failure occurrence statuses of the plurality of second cables connected to the second optical branching apparatus. With this, when the adjacent object is identified, the second cable capable of transmitting an optical signal to the second optical branching apparatus can be selected based on the connection state of the optical switch of the second optical branching apparatus and a failure occurrence status of the second cable.

Further, the second cable capable of transmitting an optical signal to the second optical branching apparatus may be the second cable capable of transmitting an optical signal to the first optical branching apparatus and having no failure in a current connection state of the optical switch of the second optical branching apparatus, among the plurality of second cables connected to the second optical branching apparatus.

With this, when the adjacent object is identified, it is possible to select the second cable capable of transmitting an optical signal to the first optical branching apparatus in the current connection state of the optical switch of the second optical branching apparatus. As a result, the adjacent object can be identified without changing the connection state of the optical switch of the second optical branching apparatus. Further, when the adjacent object is identified, the second cable on which a failure does not occur can be selected.

Further, when a second adjacent object being identified by the adjacent object identification unit 102 is a third optical brunching apparatus, the adjacent object identification unit 102 executes the above-mentioned adjacent object identification processing while regarding the third optical branching apparatus as the second optical branching apparatus. Subsequently, the landing station identification unit 103 executes the above-mentioned landing station processing. With this, even when a plurality of optical branching apparatuses is present between an optical branching apparatus being a control target and a landing station, a landing station capable of controlling the optical branching apparatus being a control target can be identified.

Further, the notification unit 104 sends the landing station being identified by the landing station identification unit 103. With this, an operator of the integrated monitoring control apparatus 10 can grasp the landing station being identified.

Further, the landing station control unit 105 prevents a terminal station apparatus of a landing station other than the landing station being identified by the landing station identification unit 103 to transmit control information to the first optical branching apparatus. With this, it is possible to stop transmission of control information from a terminal station apparatus of a landing station other than the landing station being identified by the landing station identification unit 103 to the optical branching apparatus being a control target.

### Second Example Embodiment

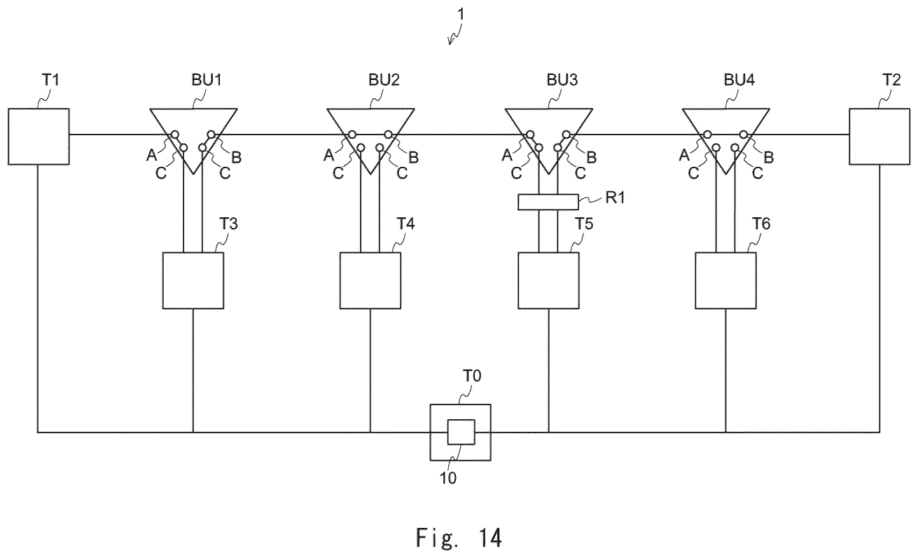

FIG. 14 is a diagram illustrating one example of the submarine cable system 1 according to an exemplary second example embodiment. The submarine cable system 1 according to the second example embodiment includes the network operation center T0 in which the integrated monitoring control apparatus 10 is installed, the one or more landing stations T1 to T6, and the one or more optical branching apparatus BU1 to BU4, and an optical branching insertion apparatus R1. The optical branching insertion apparatus R1 is an apparatus that selectively allows an optical signal to pass therethrough. Note that the submarine cable system 1 may include the freely-selected number of optical branching insertion apparatuses R1.

In the exemplary second example embodiment, the second optical branching apparatus other than the first optical branching apparatus, a landing station, and an optical branching insertion apparatus may be the adjacent object. Differences from the first example embodiment are mainly described below.

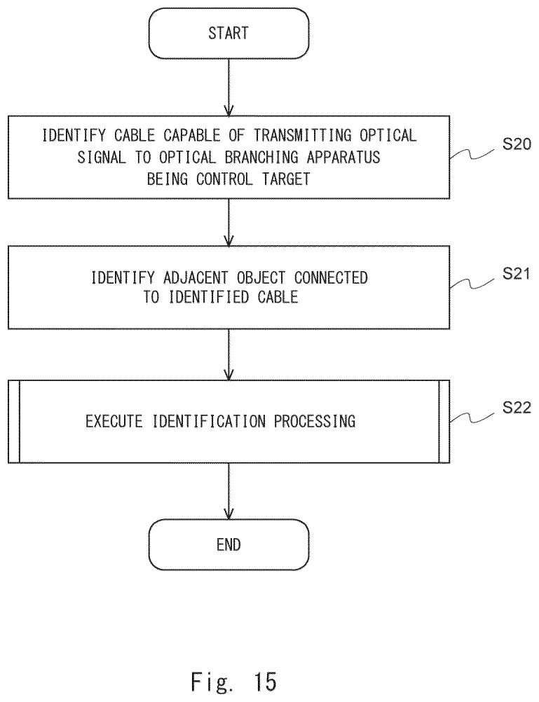

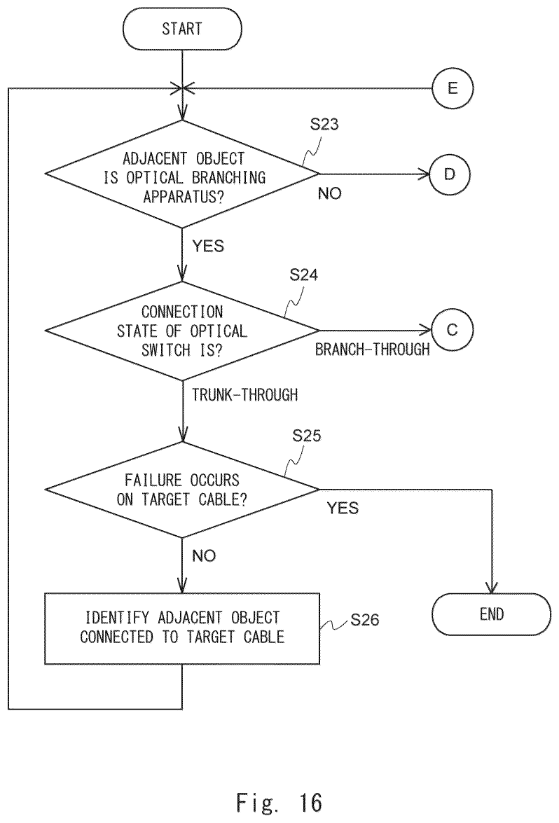

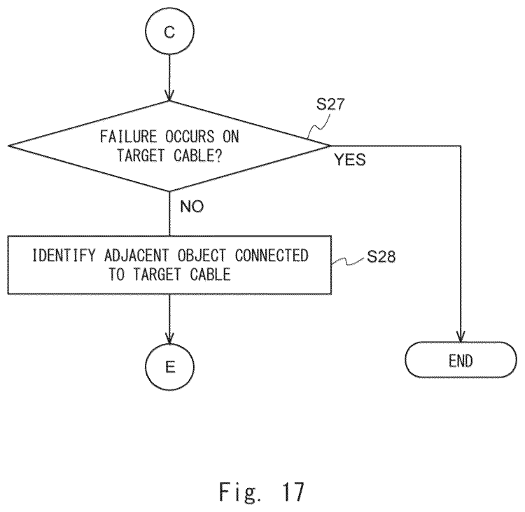

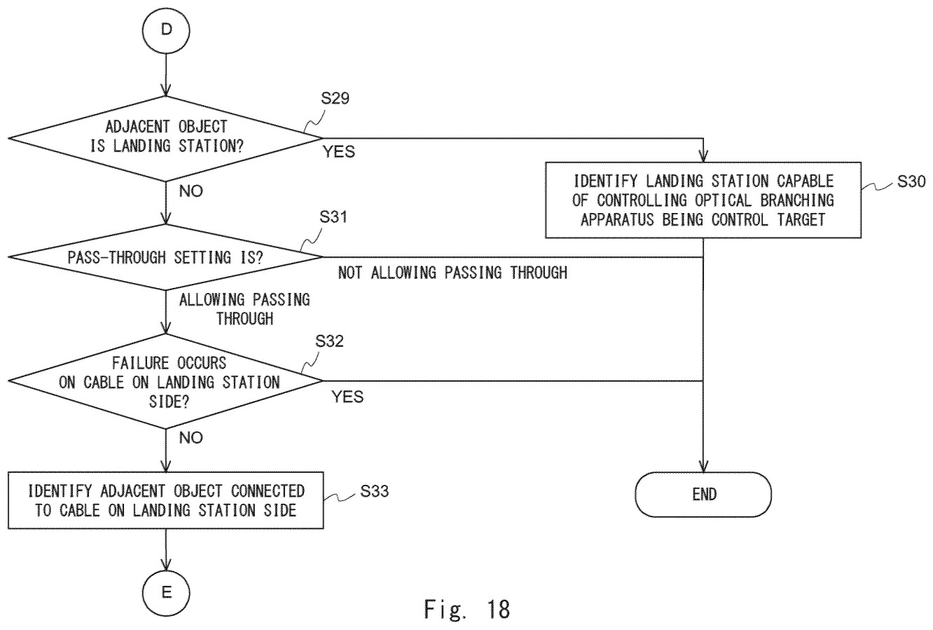

FIG. 15 to FIG. 18 are flowcharts illustrating one example of processing to be executed by the integrated monitoring control apparatus 10 according to the exemplary second example embodiment. In step S20, the integrated monitoring control apparatus 10 identifies a cable capable of transmitting an optical signal to an optical branching apparatus being a control target, based on a failure occurrence status of a plurality of cables connected to the optical branching apparatus being a control target.

In step S21, the integrated monitoring control apparatus 10 refers to the adjacent object information table, and identifies an adjacent object connected to the cable being identified in step S20.

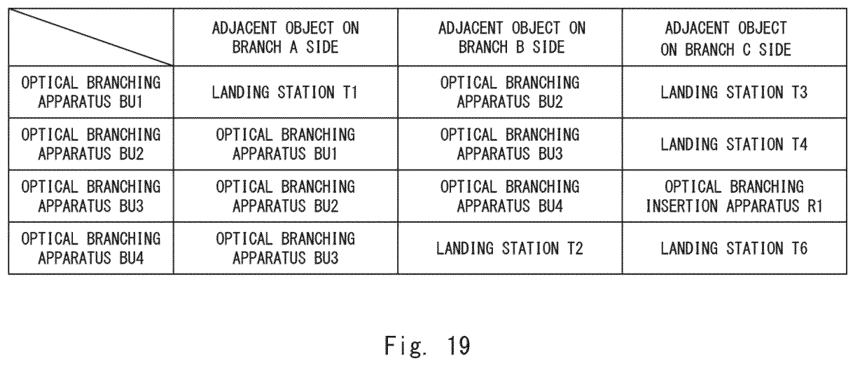

FIG. 19 is one example of the adjacent object information table according to the exemplary second example embodiment. In the adjacent object information table, the adjacent object on the branch A side, the adjacent object on the branch B side, and the adjacent object on the branch C side of each of the optical branching apparatuses BU1 to BU4 are registered. Herein, it is assumed that the optical branching apparatus BU3 is an optical branching apparatus being a control target. With reference to the adjacent object information table illustrated in FIG. 19, the adjacent object on the branch A side of the optical branching apparatus BU3 is the optical branching apparatus BU2, and the adjacent object on the branch C side is the optical branching insertion apparatus R1. In this case, the integrated monitoring control apparatus 10 identifies the optical branching apparatus BU2 as the adjacent object on the branch A side of the optical branching apparatus BU3, and identifies the optical branching insertion apparatus R1 as the adjacent object on the branch C side of the optical branching apparatus BU3.

In step S22, the integrated monitoring control apparatus 10 executes the identification processing illustrated in FIG. 16 to FIG. 18 for each of the adjacent objects being identified in step S21, and the processing in FIG. 15 is terminated.

FIG. 16 to FIG. 18 are diagrams illustrating one example of the identification processing to be executed by the integrated monitoring control apparatus 10 according to the second example embodiment. In step S23, the integrated monitoring control apparatus 10 determines whether the adjacent object being identified is an optical branching apparatus. When the adjacent object being identified is an optical branching apparatus (YES), the processing branches to step S24.

In step S24, the integrated monitoring control apparatus 10 refers to the optical switch connection state table, and determines the connection state of the optical switch of the optical branching apparatus being the adjacent object being identified. When the connection state of the optical switch is trunk-through, the processing branches to step S25.

In step S25, the integrated monitoring control apparatus 10 refers to the failure occurrence status management table, and determines whether a failure occurs on the target cable for which presence or absence of failure occurrence is not yet determined among the cables connected by the optical switch. When a failure occurs on the target cable (YES), the identification processing is terminated. In contrast, when a failure does not occur on the target cable (NO), the processing branches to step S26.

In step S26, the integrated monitoring control apparatus 10 refers to the adjacent object information table identifies the adjacent object connected to the target cable, and the processing returns to step S23. In this case, in step S23, the integrated monitoring control apparatus 10 determines whether the adjacent object being identified is an optical branching apparatus in step S25.

In contrast, when it is determined that the connection state of the optical switch is branch-through in step S24, the processing branches to step S27. In step S27, the integrated monitoring control apparatus 10 refers to the failure occurrence status management table, and determines whether a failure occurs on the target cable for which presence or absence of failure occurrence is not yet determined among the cables connected by the optical switch. When a failure occurs on the target cable (YES), the identification processing is terminated. In contrast, when a failure does not occur on the target cable (NO), the processing branches to step S28.

In step S28, the integrated monitoring control apparatus 10 refers to the adjacent object information table identifies the adjacent object connected to the target cable, and the processing returns to step S23. In this case, in step S23, the integrated monitoring control apparatus 10 determines whether the adjacent object being identified is an optical branching apparatus in step S28.

In contrast, when it is determined that the adjacent object is not an optical branching apparatus in step S23 (NO), the processing branches to step S29. In step S29, the integrated monitoring control apparatus 10 determines whether the adjacent object is a landing station. When the adjacent object is a landing station (YES), the integrated monitoring control apparatus 10 identifies the landing station being the adjacent object as a landing station capable of controlling the optical branching apparatus being a control target, and the identification processing is terminated in step S30. In contrast, when the adjacent object is not a landing station (NO), in other words, when the adjacent object is an optical branching insertion apparatus, the processing branches to step S31.

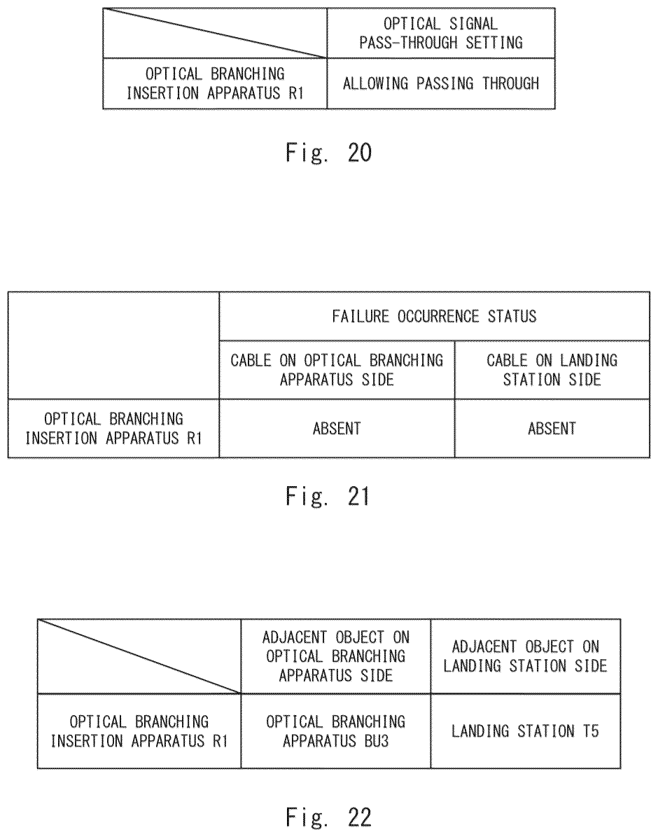

In step S31, the integrated monitoring control apparatus 10 refers to pass-through setting information relating to the optical branching insertion apparatus being the adjacent object, and determines a pass-through setting of the optical branching insertion apparatus. FIG. 20 is a diagram illustrating one example of the pass-through setting information relating to the optical branching insertion apparatus. The pass-through setting information relating to the optical branching insertion apparatus is information for specifying whether the optical branching insertion apparatus allows an optical signal to pass therethrough.

When it is determined that the pass-through setting of the optical branching insertion apparatus does not allow passing through in step S31, the identification processing is terminated. In contrast, when it is determined that the pass-through setting of the optical branching insertion apparatus allows passing through in step S31, the processing branches to step S32.

In step S32, the integrated monitoring control apparatus 10 refers to the failure occurrence status management table in which failure occurrence statuses of cables connected to the optical branching insertion apparatus are registered, which is illustrated in FIG. 21, and determines whether a failure occurs on the cable of the optical branching insertion apparatus on the landing station side.

When it is determined that a failure occurs on the cable on the landing station side in step S32 (YES), the identification processing is terminated. In contrast, when a failure does not occur on the cable on the landing station side (NO), the integrated monitoring control apparatus 10 refers to the adjacent object information table in which the adjacent objects of the optical branching insertion apparatus are registered, which is illustrated in FIG. 22, and identifies the adjacent object connected to the cable on the landing station side in step S33.

When the adjacent object is identified in step S33, the processing returns to step S23. In this case, the integrated monitoring control apparatus 10 determines whether the adjacent object being identified is an optical branching apparatus in step S33.

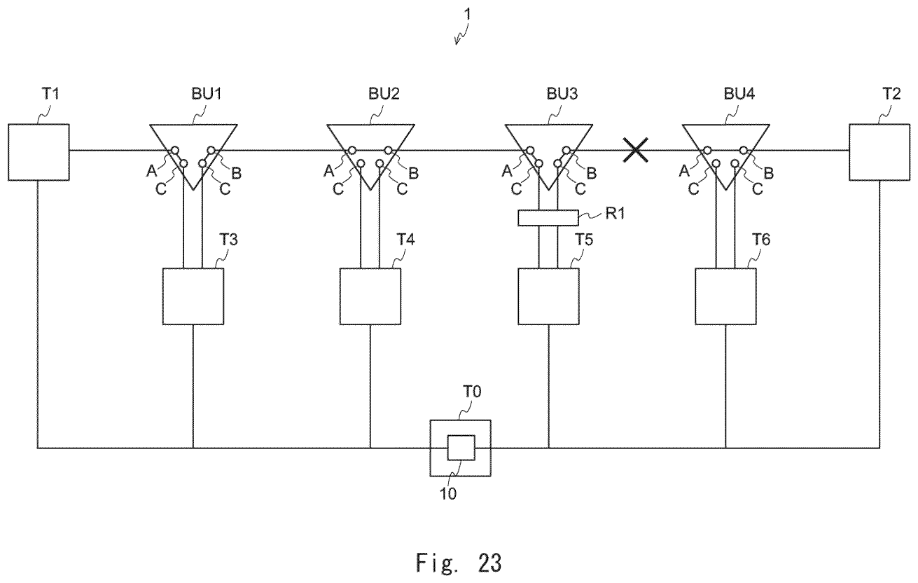

FIG. 23 is a diagram illustrating one example of the submarine cable system 1 when a cable failure according to the exemplary second example embodiment occurs. As illustrated in FIG. 23, when a failure occurs on the cable between the optical branching apparatus BU3 and the optical branching apparatus BU4, it is assumed that the optical branching apparatus BU3 is an optical branching apparatus being a control target. In this case, the adjacent objects of the optical branching apparatus BU3 are the optical branching apparatus BU2 and the optical branching insertion apparatus R1. When the optical signal pass-through setting information relating to the optical branching insertion apparatus R1 indicates pass through, and a failure does not occur on a cable between the optical branching insertion apparatus R1 and the landing station T5, the landing station T5 is identified as a landing station capable of controlling the optical branching apparatus BU3 being a control target.

In the exemplary second example embodiment, the adjacent object connected to the first optical branching apparatus may include an optical branching apparatus other than the first optical branching apparatus, a landing station, and an optical branching insertion apparatus. In a case in which the adjacent object being identified is the optical branching insertion apparatus connected to the first optical branching apparatus, when the optical branching insertion apparatus is capable of allowing an optical signal to pass therethrough, and a failure does not occur on the cable connected to the optical branching insertion apparatus, the landing station identification unit 103 identifies the landing station being connected via the cable connected to the optical branching insertion apparatus as a landing station capable of controlling the first optical branching apparatus. In other words, the landing station connected via the cable that is connected to the optical branching insertion apparatus capable of allowing an optical signal to pass therethrough and has no failure is identified as a landing station capable of controlling the optical branching apparatus being a control target. With this, in the submarine cable system including an optical branching insertion apparatus, a landing station capable of controlling the optical branching apparatus being a control target can be identified.

Further, in a case in which the adjacent object being identified is an optical branching insertion apparatus connected to an optical branching apparatus other than the first optical branching apparatus, when the optical branching insertion apparatus is capable of allowing an optical signal to pass therethrough, and a failure does not occur on the cable connected to the optical branching insertion apparatus, the landing station identification unit 103 identifies the landing station being connected via the cable connected to the optical branching insertion apparatus as a landing station capable of controlling the first optical branching apparatus. With this, in the submarine cable system including an optical branching insertion apparatus, even when one or more optical branching apparatuses are present between an optical branching apparatus being a control target and a landing station, a landing station capable of controlling the optical branching apparatus being a control target can be identified.

In the example described above, the landing station identification program 100 includes a command group (or a software code) for causing a computer to execute one or more of the functions described in the example embodiments when the program is read by the computer. The landing station identification program 100 may be stored in a non-transitory computer-readable medium or a solid storage medium. Examples of the computer-readable medium or the solid storage medium include, but are not limited to, a random access memory (RAM), a read-only memory (ROM), a flash memory, a solid-state drive (SSD), or other memory techniques, a CD-ROM, a digital versatile disk (DVD), a Blu-ray (registered trademark) disc, or other optical disc storages, and a magnetic cassette, a magnetic tape, a magnetic disc storage, or other magnetic storage devices. The program may be transmitted via a non-transitory computer-readable medium or a communication medium. Examples of the non-transitory computer-readable medium or the communication medium include, but are not limited to, a propagation signal in an electric, optical, acoustic, or other formats.

The present disclosure is not limited to the example embodiments described above, and modifications may be made as appropriate within the scope of the present disclosure.

For example, the whole or a part of the example embodiments described above can be described as, but not limited to, the following supplementary notes.

### Supplementary Note 1

A landing station identification apparatus including:
a cable identification means for identifying a first cable capable of transmitting an optical signal to a first optical branching apparatus, based on a failure occurrence status of a plurality of first cables connected to the first optical branching apparatus;
an adjacent object identification means for identifying an adjacent object connected to the first optical branching apparatus via the identified first cable and a landing station, wherein the adjacent object connected to the first optical branching apparatus includes a second optical branching apparatus other than the first optical branching apparatus; and
a landing station identification means for identifying the landing station as a landing station capable of controlling the first optical branching apparatus when the identified adjacent object is the landing station.

### Supplementary Note 2

The landing station identification apparatus according to Supplementary Note 1, wherein,
when the identified adjacent object is the second optical branching apparatus,
   the adjacent object identification means executes adjacent object identification processing of identifying an adjacent object connected to the second optical branching apparatus via a second cable capable of transmitting an optical signal to the second optical branching apparatus, among a plurality of second cables connected to the second optical branching apparatus, wherein the adjacent object connected to the second optical branching apparatus includes a third optical branching apparatus other than the first optical branching apparatus and the second optical branching apparatus, and a landing station, and
   the landing station identification means executes landing station processing of identifying the landing station as a landing station capable of controlling the first optical branching apparatus when the adjacent object connected to the second optical branching apparatus is the landing station.

### Supplementary Note 3

The landing station identification apparatus according to Supplementary Note 2, wherein the second cable capable of transmitting an optical signal to the second optical branching apparatus is identified based on a connection state of an optical switch included in the second optical branching apparatus and a failure occurrence status of a plurality of the second cables connected to the second optical branching apparatus.

### Supplementary Note 4

The landing station identification apparatus according to Supplementary Note 3, wherein the second cable capable of transmitting an optical signal to the second optical branching apparatus is a second cable being capable of transmitting an optical signal to the first optical branching apparatus and having no failure in a current connection state of the optical switch of the second optical branching apparatus, among a plurality of the second cables connected to the second optical branching apparatus.

### Supplementary Note 5

The landing station identification apparatus according to any one of Supplementary Notes 2 to 4, wherein,
when the identified adjacent object is the third optical branching apparatus,
   the adjacent object identification means executes the adjacent object identification processing while regarding the third optical branching apparatus as the second optical branching apparatus, and
   the landing station identification means executes the landing station processing.

### Supplementary Note 6

The landing station identification apparatus according to any one of Supplementary Notes 1 to 5, wherein
the adjacent object connected to the first optical branching apparatus includes an optical branching apparatus other than the first optical branching apparatus, the landing station, and an optical branching insertion apparatus, and
in a case in which the identified adjacent object is the optical branching insertion apparatus connected to the first optical branching apparatus, when the optical branching insertion apparatus is capable of allowing an optical signal to pass through, and a failure does not occur on a cable connected to the optical branching insertion apparatus, the landing station identification means identifies a landing station connected via the cable connected to the optical branching insertion apparatus as a landing station capable of controlling the first optical branching apparatus.

### Supplementary Note 7

The landing station identification apparatus according to Supplementary Note 6, wherein, in a case in which the identified adjacent object is the optical branching insertion apparatus connected to an optical branching apparatus other than the first optical branching apparatus, when the optical branching insertion apparatus is capable of allowing an optical signal to pass through, and a failure does not occur on a cable connected to the optical branching insertion apparatus, the landing station identification means identifies a landing station connected via the cable connected to the optical branching insertion apparatus as a landing station capable of controlling the first optical branching apparatus.

### Supplementary Note 8

The landing station identification apparatus according to any one of Supplementary Notes 1 to 7, further including a notification means for notifying a landing station being identified by the landing station identification means.

### Supplementary Note 9

The landing station identification apparatus according to any one of Supplementary Notes 1 to 8, further including a landing station control means for preventing a terminal station apparatus of a landing station other than a landing station being identified by the landing station identification means from transmitting control information to the first optical branching apparatus.

### Supplementary Note 10

A landing station identification method including, by a computer:
identifying a first cable capable of transmitting an optical signal to a first optical branching apparatus, based on a failure occurrence status of a plurality of first cables connected to the first optical branching apparatus;
identifying an adjacent object connected to the first optical branching apparatus via the identified first cable and a landing station, wherein the adjacent object connected to the first optical branching apparatus includes a second optical branching apparatus other than the first optical branching apparatus; and
identifying the landing station as a landing station capable of controlling the first optical branching apparatus when the identified adjacent object is the landing station.

### Supplementary Note 11

The landing station identification method according to Supplementary Note 10, wherein,
when the identified adjacent object is the second optical branching apparatus,
the computer executes adjacent object identification processing of identifying an adjacent object connected to the second optical branching apparatus via a second cable capable of transmitting an optical signal to the second optical branching apparatus, among a plurality of second cables connected to the second optical branching apparatus, the adjacent object connected to the second optical branching apparatus including a third optical branching apparatus other than the first optical branching apparatus and the second optical branching apparatus, and a landing station, and identifies the landing station as a landing station capable of controlling the first optical branching apparatus when the adjacent object connected to the second optical branching apparatus is the landing station.

### Supplementary Note 12

The landing station identification method according to Supplementary Note 11, wherein,
when the identified adjacent object is the third optical branching apparatus,
the computer executes the adjacent object identification processing while regarding the third optical branching apparatus as the second optical branching apparatus, and executes the landing station processing.

### Supplementary Note 13

The landing station identification method according to any one of Supplementary Notes 10 to 12, wherein
the adjacent object connected to the first optical branching apparatus includes an optical branching apparatus other than the first optical branching apparatus, the landing station, and an optical branching insertion apparatus, and,
in a case in which the identified adjacent object is the optical branching insertion apparatus connected to the first optical branching apparatus, when the optical branching insertion apparatus is capable of allowing an optical signal to pass through, and a failure does not occur on a cable connected to the optical branching insertion apparatus, the computer identifies a landing station connected via the cable connected to the optical branching insertion apparatus as a landing station capable of controlling the first optical branching apparatus.

### Supplementary Note 14

The landing station identification method according to Supplementary Note 13, wherein,
in a case in which the identified adjacent object is the optical branching insertion apparatus connected to an optical branching apparatus other than the first optical branching apparatus, when the optical branching insertion apparatus is capable of allowing an optical signal to pass through, and a failure does not occur on a cable connected to the optical branching insertion apparatus, the computer identifies a landing station connected via the cable connected to the optical branching insertion apparatus as a landing station capable of controlling the first optical branching apparatus.

### Supplementary Note 15

A non-transitory storage medium configured to store a landing station identification program causing a computer to execute:
identifying a first cable capable of transmitting an optical signal to a first optical branching apparatus, based on a failure occurrence status of a plurality of first cables connected to the first optical branching apparatus;
identifying an adjacent object connected to the first optical branching apparatus via the identified first cable and a landing station, wherein the adjacent object connected to the first optical branching apparatus includes a second optical branching apparatus other than the first optical branching apparatus; and
identifying the landing station as a landing station capable of controlling the first optical branching apparatus when the identified adjacent object is the landing station.

### Supplementary Note 16

The non-transitory storage medium according to Supplementary Note 15, wherein,
when the identified adjacent object is the second optical branching apparatus,
the computer is caused to:
   execute adjacent object identification processing of identifying an adjacent object connected to the second optical branching apparatus via a second cable capable of transmitting an optical signal to the second optical branching apparatus, among a plurality of second cables connected to the second optical branching apparatus, the adjacent object connected to the second optical branching apparatus including a third optical branching apparatus other than the first optical branching apparatus and the second optical branching apparatus, and a landing station; and
   identify the landing station as a landing station capable of controlling the first optical branching apparatus when the adjacent object connected to the second optical branching apparatus is the landing station.

### Supplementary Note 17

The non-transitory storage medium according to Supplementary Note 16, wherein,
when the identified adjacent object is the third optical branching apparatus,
the computer is caused to:
   execute the adjacent object identification processing while regarding the third optical branching apparatus as the second optical branching apparatus; and
   execute the landing station processing.

### Supplementary Note 18

The non-transitory storage medium according to any one of Supplementary Notes 15 to 17, wherein
the adjacent object connected to the first optical branching apparatus includes an optical branching apparatus other than the first optical branching apparatus, the landing station, and an optical branching insertion apparatus, and,
in a case in which the identified adjacent object is the optical branching insertion apparatus connected to the first optical branching apparatus, when the optical branching insertion apparatus is capable of allowing an optical signal to pass through, and a failure does not occur on a cable connected to the optical branching insertion apparatus, the computer is caused to identify a landing station connected via the cable connected to the optical branching insertion apparatus as a landing station capable of controlling the first optical branching apparatus.

### Supplementary Note 19

The non-transitory storage medium according to Supplementary Note 18, wherein,
in a case in which the identified adjacent object is the optical branching insertion apparatus connected to an optical branching apparatus other than the first optical branching apparatus, when the optical branching insertion apparatus is capable of allowing an optical signal to pass through, and a failure does not occur on a cable connected to the optical branching insertion apparatus, the computer is caused to identify a landing station connected via the cable connected to the optical branching insertion apparatus as a landing station capable of controlling the first optical branching apparatus.

### Reference Signs List

1 SUBMARINE CABLE SYSTEM
10 INTEGRATED MONITORING CONTROL APPARATUS
11 PROCESSOR
12 COMMUNICATION INTERFACE
13 STORAGE APPARATUS
100 LANDING STATION IDENTIFICATION PROGRAM
101 CABLE IDENTIFICATION UNIT
102 ADJACENT OBJECT IDENTIFICATION UNIT
103 LANDING STATION IDENTIFICATION UNIT
104 NOTIFICATION UNIT
105 LANDING STATION CONTROL UNIT
BU1 to BU4 OPTICAL BRANCHING APPARATUS
A to C PORT
R1 OPTICAL BRANCHING INSERTION APPARATUS
T0 NETWORK OPERATION CENTER
T1 to T6 LANDING STATION
T11 MONITORING CONTROL APPARATUS
T12 TERMINAL STATION APPARATUS
T13 TRANSMISSION PATH MONITORING APPARATUS
T31 MONITORING CONTROL APPARATUS
T32, T33 TERMINAL STATION APPARATUS
T34 TRANSMISSION PATH MONITORING APPARATUS

What is claimed is:

1. A landing station identification apparatus comprising:
a memory configured to store instructions; and
a processor configured to execute the instructions to:
identify a first cable capable of transmitting an optical signal to a first optical branching apparatus, based on a failure occurrence status of a plurality of first cables connected to the first optical branching apparatus;
identify an adjacent object connected to the first optical branching apparatus via the identified first cable and a landing station, wherein the adjacent object connected to the first optical branching apparatus includes a second optical branching apparatus other than the first optical branching apparatus; and
identify the landing station as a landing station capable of controlling the first optical branching apparatus when the identified adjacent object is the landing station.

2. The landing station identification apparatus according to claim 1, wherein,
when the identified adjacent object is the second optical branching apparatus, the processor is configured to execute:
adjacent object identification processing of identifying an adjacent object connected to the second optical branching apparatus via a second cable capable of transmitting an optical signal to the second optical branching apparatus, among a plurality of second cables connected to the second optical branching apparatus, wherein the adjacent object connected to the second optical branching apparatus includes a third optical branching apparatus other than the first optical branching apparatus and the second optical branching apparatus, and a landing station; and
landing station identification processing of identifying the landing station as a landing station capable of controlling the first optical branching apparatus when the adjacent object connected to the second optical branching apparatus is the landing station.

3. The landing station identification apparatus according to claim 2, wherein the second cable capable of transmitting an optical signal to the second optical branching apparatus is identified based on a connection state of an optical switch included in the second optical branching apparatus and a failure occurrence status of a plurality of the second cables connected to the second optical branching apparatus.

4. The landing station identification apparatus according to claim 3, wherein the second cable capable of transmitting an optical signal to the second optical branching apparatus is a second cable being capable of transmitting an optical signal to the first optical branching apparatus and having no failure in a current connection state of the optical switch of the second optical branching apparatus, among a plurality of the second cables connected to the second optical branching apparatus.

5. The landing station identification apparatus according to claim 2, wherein,
when the identified adjacent object is the third optical branching apparatus, the processor is configured to execute:
the adjacent object identification processing while regarding the third optical branching apparatus as the second optical branching apparatus; and
the landing station identification processing.

6. The landing station identification apparatus according to claim 1, wherein
the adjacent object connected to the first optical branching apparatus includes an optical branching apparatus other than the first optical branching apparatus, the landing station, and an optical branching insertion apparatus, and,
the processor is configured to execute the instructions to identify a landing station connected via the cable connected to the optical branching insertion apparatus as a landing station capable of controlling the first optical branching apparatus in a case in which the identified adjacent object is the optical branching insertion apparatus connected to the first optical branching apparatus, when the optical branching insertion apparatus is capable of allowing an optical signal to pass through, and a failure does not occur on a cable connected to the optical branching insertion apparatus.

7. The landing station identification apparatus according to claim 6, wherein, the processor is configured to execute the instructions to identify a landing station connected via the cable connected to the optical branching insertion apparatus as a landing station capable of controlling the first optical branching apparatus in a case in which the identified adjacent object is the optical branching insertion apparatus connected to an optical branching apparatus other than the first optical branching apparatus, when the optical branching insertion apparatus is capable of allowing an optical signal to pass through, and a failure does not occur on a cable connected to the optical branching insertion apparatus.

8. The landing station identification apparatus according to claim 1, the processor is further configured to execute the instructions to notify the identified landing station.

9. The landing station identification apparatus according to claim 1, the processor is further configured to execute the instructions to prevent a terminal station apparatus of a landing station other than the identified landing station from transmitting control information to the first optical branching apparatus.

10. A landing station identification method comprising, by a computer:
identifying a first cable capable of transmitting an optical signal to a first optical branching apparatus, based on a failure occurrence status of a plurality of first cables connected to the first optical branching apparatus;
identifying an adjacent object connected to the first optical branching apparatus via the identified first cable and a landing station, wherein the adjacent object connected to the first optical branching apparatus includes a second optical branching apparatus other than the first optical branching apparatus; and
identifying the landing station as a landing station capable of controlling the first optical branching apparatus when the identified adjacent object is the landing station.

11. The landing station identification method according to claim 10, wherein,
when the identified adjacent object is the second optical branching apparatus,
the computer executes adjacent object identification processing of identifying an adjacent object connected to the second optical branching apparatus via a second cable capable of transmitting an optical signal to the second optical branching apparatus, among a plurality of second cables connected to the second optical branching apparatus, the adjacent object connected to the second optical branching apparatus including a third optical branching apparatus other than the first optical branching apparatus and the second optical branching apparatus, and a landing station, and identifies the landing station as a landing station capable of controlling the first optical branching apparatus when the adjacent object connected to the second optical branching apparatus is the landing station.

12. The landing station identification method according to claim 11, wherein,
when the identified adjacent object is the third optical branching apparatus,
the computer executes the adjacent object identification processing while regarding the third optical branching apparatus as the second optical branching apparatus, and executes the landing station identification processing.

13. The landing station identification method according to claim 10, wherein
the adjacent object connected to the first optical branching apparatus includes an optical branching apparatus other than the first optical branching apparatus, the landing station, and an optical branching insertion apparatus, and,
in a case in which the identified adjacent object is the optical branching insertion apparatus connected to the first optical branching apparatus, when the optical branching insertion apparatus is capable of allowing an optical signal to pass through, and a failure does not occur on a cable connected to the optical branching insertion apparatus, the computer identifies a landing station connected via the cable connected to the optical branching insertion apparatus as a landing station capable of controlling the first optical branching apparatus.

14. The landing station identification method according to claim 13, wherein,
in a case in which the identified adjacent object is the optical branching insertion apparatus connected to an optical branching apparatus other than the first optical branching apparatus, when the optical branching insertion apparatus is capable of allowing an optical signal to pass through, and a failure does not occur on a cable connected to the optical branching insertion apparatus, the computer identifies a landing station connected via the cable connected to the optical branching insertion apparatus as a landing station capable of controlling the first optical branching apparatus.

15. A non-transitory storage medium configured to store a landing station identification program causing a computer to execute:
identifying a first cable capable of transmitting an optical signal to a first optical branching apparatus, based on a failure occurrence status of a plurality of first cables connected to the first optical branching apparatus;
identifying an adjacent object connected to the first optical branching apparatus via the identified first cable and a landing station, wherein the adjacent object connected to the first optical branching apparatus includes a second optical branching apparatus other than the first optical branching apparatus; and
identifying the landing station as a landing station capable of controlling the first optical branching apparatus when the identified adjacent object is the landing station.

16. The non-transitory storage medium according to claim 15, wherein,
when the identified adjacent object is the second optical branching apparatus,
the computer is caused to:
execute adjacent object identification processing of identifying an adjacent object connected to the second optical branching apparatus via a second cable capable of transmitting an optical signal to the second optical branching apparatus, among a plurality of second cables connected to the second optical branching apparatus, the adjacent object connected to the second optical branching apparatus including a third optical branching apparatus other than the first optical branching apparatus and the second optical branching apparatus, and a landing station; and
identify the landing station as a landing station capable of controlling the first optical branching apparatus when the adjacent object connected to the second optical branching apparatus is the landing station.

17. The non-transitory storage medium according to claim 16, wherein,
when the identified adjacent object is the third optical branching apparatus,
the computer is caused to:
execute the adjacent object identification processing while regarding the third optical branching apparatus as the second optical branching apparatus; and
execute the landing station identification processing.

18. The non-transitory storage medium according to claims 15, wherein
the adjacent object connected to the first optical branching apparatus includes an optical branching apparatus other than the first optical branching apparatus, the landing station, and an optical branching insertion apparatus, and,
in a case in which the identified adjacent object is the optical branching insertion apparatus connected to the first optical branching apparatus, when the optical branching insertion apparatus is capable of allowing an optical signal to pass through, and a failure does not occur on a cable connected to the optical branching insertion apparatus, the computer is caused to identify a landing station connected via the cable connected to the optical branching insertion apparatus as a landing station capable of controlling the first optical branching apparatus.

19. The non-transitory storage medium according to claim 18, wherein,
in a case in which the identified adjacent object is the optical branching insertion apparatus connected to an optical branching apparatus other than the first optical branching apparatus, when the optical branching insertion apparatus is capable of allowing an optical signal to pass through, and a failure does not occur on a cable connected to the optical branching insertion apparatus, the computer is caused to identify a landing station connected via the cable connected to the optical branching insertion apparatus as a landing station capable of controlling the first optical branching apparatus.
